(19) United States
(12) Patent Application Publication
(10) Pub. No.: US 2005/0216902 A1
(43) Pub. Date: Sep. 29, 2005

(54) Method and system for vehicle software configuration update management

(75) Inventor: Mark S. Schaefer, Sterling Heights, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/806,868

(22) Filed: Mar. 23, 2004

(51) Int. Cl. G06F 9/44

(52) U.S. Cl. 717/168

(57) ABSTRACT

The present invention provides a system and method of managing a software configuration update of a vehicle. A first software module is identified and vehicle configuration data representative of a first vehicle software configuration is retrieved. A determination is made whether the first software module is compatible with the first vehicle software configuration at a call center. A second vehicle software configuration is sent from the call center to a telematics unit via a wireless network based on the determination. A computer usable medium with suitable computer program code is employed for managing the software configuration update of the vehicle.

### FIELD OF THE INVENTION

In general, the invention relates to software configuration management. More specifically, the invention relates to a method and system for vehicle software configuration update management.

### BACKGROUND OF THE INVENTION

One of the fastest growing areas of communications technology is related to automobile network solutions. The demand and potential for wireless vehicle communication, networking and diagnostics services have recently increased. Although many vehicles on the road today have limited wireless communication functions, such as unlocking a door and setting or disabling a car alarm, new vehicles offer additional wireless communication systems that help personalize comfort settings, run maintenance and diagnostic functions, place telephone calls, access call center information, update controller systems, determine vehicle location, assist in tracking vehicle after a theft of the vehicle and provide other vehicle related services. Drivers can call telematic call centers and receive navigational, concierge, emergency, and location services, as well as other specialized help as locating the geographical location of a stolen vehicle and honking the horn of a vehicle when the owner cannot locate it in a large parking garage.

The automation of an increasing number of vehicle functions is dependent on the use of multiple and complex software modules. Many of the software modules are interdependent on one or more other software modules installed within the vehicle. With the constant evolution of technologies, upgrades are frequently made to vehicle software modules to provide additional vehicle features or improve the performance of existing vehicle functions. Upgrading a software module from one version to another can introduce software module incompatibility problems where the newly installed software module is incompatible with one or more software modules previously installed in the vehicle. To avoid such a problem, vehicle technicians perform time consuming compatibility checks between software modules by analyzing the interdependencies between the new software module to be installed and existing software modules in the vehicle prior to the installation of a new software module. The introduction of a new version of a software module in a vehicle often requires the upgrading of other software modules to ensure that the software modules are able to continue to interact with each other.

The inadvertent installation of an incompatible software module in the vehicle by a user can lead to vehicle function problems. The troubleshooting of such errors to identify the specific software module incompatibilities by vehicle technicians can be time consuming and expensive.

It is desirable therefore, to provide a method and system for vehicle software configuration update management, that overcomes the challenges and obstacles described above.

### SUMMARY OF THE INVENTION

One aspect of the invention presents a method of managing a software configuration update of a vehicle. The method comprises identifying a first software module and retrieving vehicle configuration data representative of a first vehicle software configuration. The method determines whether the first software module is compatible with the first vehicle software configuration at a call center and sends a second vehicle software configuration from the call center to a telematics unit via a wireless network based on the determination.

Another aspect of the present invention provides a computer readable medium storing a computer program for managing a software configuration update of a vehicle. The computer readable code identifies a first software module. The computer readable code retrieves vehicle configuration data representative of a first vehicle software configuration. The computer readable code determines whether the first software module is compatible with the first vehicle software configuration at a call center. The computer readable code sends a second vehicle software configuration from the call center to a telematics unit via a wireless network based on the determination.

Another aspect of the present invention provides a system for managing a software configuration update of a vehicle. The system identifies a first software module and retrieves vehicle configuration data representative of a first vehicle software configuration. The system determines whether the first software module is compatible with the first vehicle software configuration at a call center and sends a second vehicle software configuration from the call center to a telematics unit via a wireless network based on the determination.

The foregoing and other features and advantages of the invention will become further apparent from the following detailed description of the presently preferred embodiment, read in conjunction with the accompanying drawings. The detailed description and drawings are merely illustrative of the invention rather than limiting the scope of the invention being defined by the appended claims and equivalents thereof.

### BRIEF DESCRIPTION OF THE FIGURES

FIG. 1 is a schematic diagram of a system for managing software configuration update of a vehicle in accordance with one embodiment of the present invention;

FIG. 2 is a schematic diagram of the telematic call center and a vehicle in accordance with one embodiment of the present invention; and

FIG. 3 is a flowchart for managing software configuration update of a vehicle in accordance with one embodiment of the present invention.

### DETAILED DESCRIPTION OF THE PRESENTLY PREFERRED EMBODIMENTS

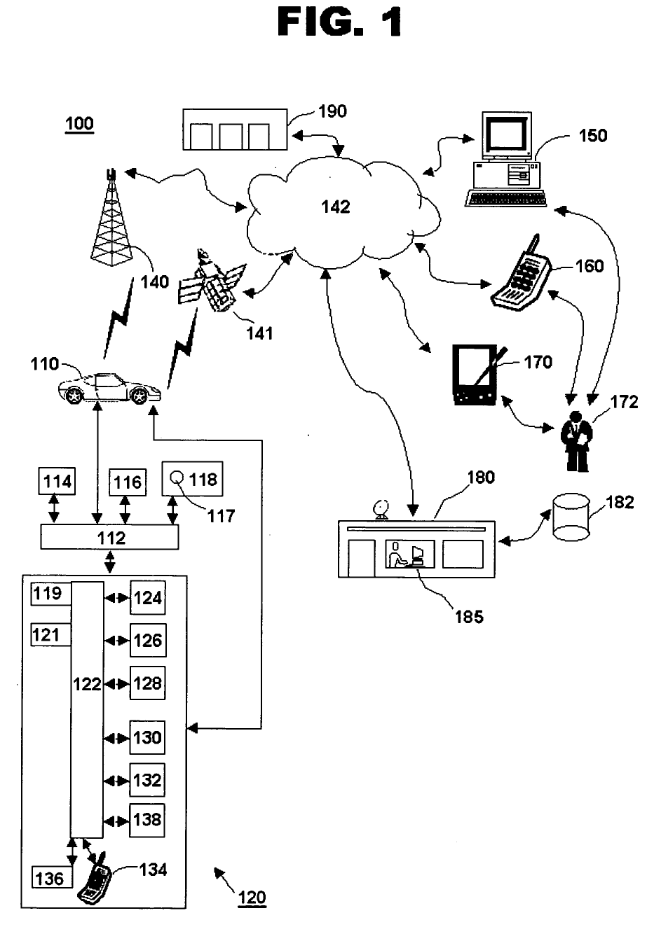

FIG. 1 is a schematic diagram of a system for vehicle software configuration management using a wireless communication system in accordance with one embodiment of the present invention at 100. The vehicle software configuration management system 100 includes one or more vehicles 110, a telematics unit 120, one or more wireless carrier systems 140 or satellite carrier systems 141, one or more communication networks 142, and one or more call centers 180. The vehicle 110 is a vehicle such as a car or truck equipped with suitable hardware and software for transmitting and receiving voice and data communications.

The vehicle 110 via the telematics unit 120 transmits and receives radio transmissions from the wireless carrier system 140, or the satellite carrier system 141. The wireless carrier system 140, the satellite carrier system 141 or any other suitable communication system communicatively couples the vehicle 110 to the communication network 142. Telematics unit 120 is, in certain embodiments, communicatively coupled to audio device 118 and speakers 117.

The communication network 142 includes services from mobile telephone switching offices, wireless networks, public-switched telephone networks (PSTN), and Internet protocol (IP) networks. The communication network 142 comprises a wired network, an optical network, a fiber network, another wireless network, or any combination thereof. The communication network 142 is communicatively coupled to the vehicle 110 via the wireless carrier system 140, or via the satellite carrier system 141. The communication network 142 communicatively couples the wireless carrier system 140 or the satellite carrier system 141 to a user computer 150, a wireless or wired phone 160, a handheld device 170, such as a personal digital assistant, and the call center 180. The communication network 142 uses any appropriate wireless technology, including CDMA, TDMA, FDMA, and GSM or satellite carrier system.

The communication network 142 can transmit and receive short messages according to established protocols such as IS-637 standards for short message service (SMS), IS-136 air-interface standards for SMS, and GSM 03.40 and 09.02 standards.

The call center 180 is a location where many calls can be received and serviced at the same time, or where many calls can be sent at the same time. In one embodiment, the call center 180 is a voice call center, providing verbal communications between a communication services advisor 185 in the call center 180 and a subscriber. In another embodiment, the call center 180 contains any combination of hardware or software facilitating data transmissions between the call center 180 and the vehicle 110. In one embodiment of the invention, the call center is a telematics call center, facilitating communications to and from the telematics unit 120 in the vehicle 110. In a further embodiment, the call center 180 combines any of the previously described functions. In a further embodiment, call center 180 can transmit and receive data via data signal for vehicle maintenance, to telematics unit 120 in mobile vehicle 110 and to a vehicle service center 190 through wireless carrier system 140, satellite carrier systems 141, or communication network 142. Call center 180 can store status data for vehicle maintenance in a call center database 182 and provide that data to subscriber, service center, or vehicle manufacturer with proper authorization

The communication services advisor 185 is a real advisor or a virtual advisor. A real advisor is a human being in verbal communication with a user or subscriber. A virtual advisor is a synthesized voice interface responding to requests from user or subscriber. In one embodiment, virtual advisor includes one or more recorded messages. In another embodiment, virtual advisor generates voice messages using a text to speech synthesis engine (TTS). In another embodiment virtual advisor includes both recorded and TTS generated messages.

The call center 180 provides services to telematics unit 120. The communication services advisor 185 provides one of a number of support services to a subscriber. The call center 180 can transmit data via data signal to the telematics unit 120 in vehicle 110 through wireless carrier system 140, satellite carrier systems 141, or communication network 142. Call center 180 is in communication with central database 182.

In one embodiment of the invention, the user 172 has a local provisioning system such as a user computer 150 or a handheld device 170. The local provisioning system has a wireless modem to send data through wireless carrier system 140, or satellite carrier system 141, which connects to communication network 142. In another embodiment, local provisioning system has a wired modem, which connects to communications network 142. The data is received at call center 180. The call center 180 has any suitable hardware and software capable of providing web services to help transmit messages and data signals from local provisioning system, such as, a user computer 150 or a handheld device 170 to the telematics unit 120 in the vehicle 110. In another embodiment, a user computer 150 or a handheld device 170 has suitable hardware and software to connect to the vehicle 110 using a direct link to a vehicle onboard data port.

In one embodiment of the invention, the telematics unit 120 includes a digital signal processor (DSP) 122 connected to a wireless modem 124, a global positioning system (GPS) receiver or GPS unit 126, and an in-vehicle memory 128. The DSP 122 is also referred to as a microcontroller, controller, ASIC, host processor, or vehicle communications processor. The GPS unit 126 provides longitude and latitude coordinates of the vehicle 110, as well as a time stamp and a date stamp. In other embodiments of the invention, DSP 122 is connected to at least one of an email appliance 136, wireless microphone 130, one or more speakers 132, and an embedded or in-vehicle phone 134. In another embodiment, DSP 122 is connected to other functional devices 119,121, and 138.

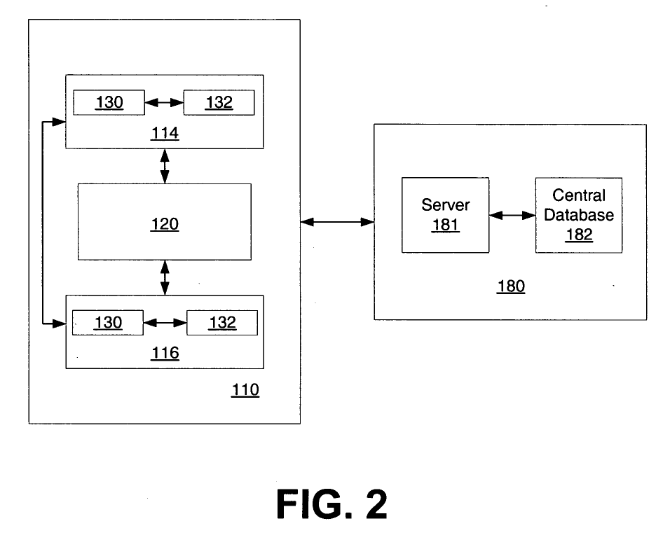

The telematics unit 120 is communicatively coupled to various vehicle components via a vehicle communication bus 112. Examples of vehicle components include vehicle control modules 114, and vehicle sensors 116. Many vehicle components 114, 116 require a dedicated software module to enable operation of the vehicle component 114, 116. Examples of vehicle control modules 114 include, but are not limited to, the engine control module and the brake control module. In one embodiment, vehicle components 114, 116 that require a dedicated software module include a module processor 130 and module memory 132. In another embodiment, vehicle components 114, 116 that require a dedicated software module include a module memory 132. Module processor 130 and module memory 132 may be in communication with components 114, 116 as illustrated in FIG. 1. In another embodiment, as illustrated if FIG. 2, module processor 130 and module memory 132 are carried in components 114, 116.

In one embodiment, vehicle component 114 operates in response to data received from the vehicle component 116. The vehicle component 114 includes a first software module that communicates with a second software module associated with the vehicle component 116. The first software module includes a stub function that defines the interfaces and software interdependencies associated with the second software module. The second software module includes a complementary stub function that defines the interfaces and software interdependencies associated with the first software module. The stub function for the first software module should match the complementary stub function of the second software module to ensure efficient operation of the vehicle functions associated with the vehicle components 114, 116.

FIG. 2 is a schematic diagram of the telematics call center 180 and vehicle 110 in accordance with one embodiment of the present invention. The telematics call center 180 includes a server 181 and a central database 182. The server 181 initiates requests to and responds to requests from the telematics unit 120 and facilitates the transfer of data between the central database 182 and the telematics unit 120. Every vehicle 110 includes a predefined set of software modules to enable operation of many of the vehicle components 114, 116 of that vehicle 110. The configuration data for a specific vehicle 110 includes a listing of the predefined set of software modules and the versions of the software modules actually installed in the vehicle 110. The configuration data for a vehicle 110 depends on vehicle specific factors including, but not limited to, vehicle make, vehicle model, vehicle year, and customized vehicle features.

In one embodiment, the central database 182 maintains a record for every vehicle 110 in the software configuration management system 100. In one embodiment, a unique vehicle identification tag is assigned to every vehicle 110. The vehicle specific records in the central database 182 are maintained according to the unique vehicle identification tag assigned to the vehicle 110. In one embodiment, the unique vehicle identification tag is the vehicle identification number (VIN) for the vehicle 110. Every vehicle 110 has its own record and every record includes vehicle specific configuration data. In another embodiment, the vehicle configuration data is stored in the telematics unit 120. The vehicle configuration data includes a listing of the software modules and the versions of the software modules that have actually been installed in the vehicle 110. The actual software modules in the vehicle 110 reside in the vehicle component memory 132. For example, the engine controller software module resides in the engine controller module memory. Every software module includes a stub function that defines the interfaces and software interdependencies between that software module and one or more other software modules.

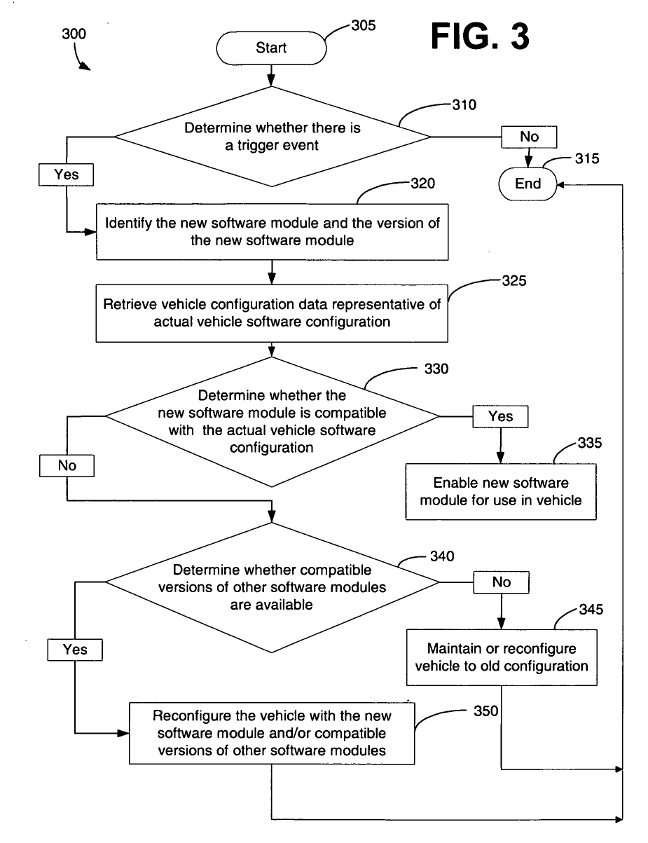

FIG. 3 is a flowchart for a method for managing the software configuration update of vehicle 110 in accordance with one embodiment of the present invention. A predefined set of software modules are installed in new vehicles 110. Individual vehicle software modules are periodically updated to provide additional vehicle features or improve performance of existing vehicle functions. Many software modules interact with one of more other software modules. Such interactions involve the transmission or exchange of data between different software modules in the vehicle. In one embodiment, when a new software module, or an updated version of an existing software module is installed in a vehicle 110, the server 181 performs compatibility checks at the telematics call center 180 prior to the installation of the new software module to ensure that the new software module has the appropriate interfaces to interact with the other software modules in the vehicle 110. If necessary, other software modules in the vehicle 110 are updated by the telematics call center 180 to ensure that software interdependencies between different software modules in the vehicle 110 are maintained. If the software interdependencies cannot be maintained, the new software module is not installed in the vehicle 110.

In one embodiment, when a new version of a software module has been installed in a vehicle 110, the telematics unit 120 detects the presence of the newly installed software module and requests a compatibility check from the telematics call center 180. The server 181 at the telematics call center 180 initiates a compatibility check to determine whether other software modules installed in the vehicle 110 require updating to maintain software interdependencies between the different software modules in the vehicle 110. If compatible versions of the other software modules are not available for the vehicle 110, the newly installed software is replaced with a previous version of the software module that is known to be compatible with the other software modules in the vehicle 110.

The method for managing the software configuration update of a vehicle 300 begins (305) with determining whether there is a trigger event (block 310). The trigger event initiates a determination of whether a new version of a software module is compatible with the other software modules previously installed in the vehicle 110. In one embodiment, the trigger event is a software request flag generated by the telematics unit 120 when the telematics unit 120 issues a software request to the server 181 at the telematics call center 110 for a specific version of a software module, prior to the installation of that new software module in the vehicle 110. In one embodiment, the telematics unit 120 issues a software request for each of the software modules installed in the vehicle 110 on a periodic basis to ensure that the latest available version of the software modules available for the vehicle 110 are installed in the vehicle 110. In another embodiment, the telematics unit 120 receives a notification from the telematics call center 180 when an upgraded version of a software module is available. The telematics unit 120 then issues a software request to the server 181. In another embodiment, the telematics unit 120 issues a software install flag to the telematics call center 180 when the telematics unit 120 detects that a new software module has been installed in the vehicle 110.

If no trigger event is detected, no further action is taken (block 315). If a trigger event is detected, the new software module and the version of the software module are identified (block 320). If the trigger event is a software request flag, the telematics unit 120 identifies the new software module and the version of the new software module of the software requested from the telematics call center 180. If the trigger event detected is a software install flag, the telematics unit 120 identifies the newly installed software module and the version of the newly installed software module.

Server 181 retrieves the vehicle configuration data, representative of the actual software configuration of the vehicle 110 from the telematics call center 180 (block 325). In one embodiment, the telematics unit 120 stores the vehicle configuration data in the in vehicle memory 128. The server 181 issues a request to the telematics unit 120 for the vehicle configuration data and the telematics unit 120 transmits the vehicle configuration data to the server 181. In another embodiment, the vehicle configuration data for each vehicle is stored in a central database 182 at the telematics call center 180. The vehicle configuration data for each vehicle is stored according to a vehicle identification tag for the vehicle, such as for example, a vehicle identification number. The vehicle configuration data includes a listing of all of the software modules and the versions of each of the software modules actually installed in the vehicle 110.

The server 181 determines whether the new software module is compatible with the vehicle software configuration, in other words whether the new software module is compatible with the software modules already installed in the vehicle 110 (block 330). Every software module that interfaces with one or more different software modules includes a stub function for every interface with another software module. For example, if the new software module is expected to interface with a first and a second software module in the vehicle 110, the new software module will include two stub functions—a first stub function and a second stub function. The first stub function defines the software interdependencies between the new software module and the first software module and the second stub function defines the software interdependencies between the new software module and the second software module. The first software module includes a complementary stub function that defines the software interdependencies between the first software module and the new software module. Similarly, the second software module includes a complementary stub function that defines the software interdependencies between the second software module and the new software module. In order for the new software module to be compatible with the first software module, the software interdependencies defined in the first stub function for the new software module have to match the interdependencies defined in the complementary stub function in the first software module. Similarly, in order for the new software module to be compatible with the second software module, the software interdependencies defined in the second stub function for the new software module have to match the software interdependencies defined in the complementary stub function in the second software module.

A determination of whether a new software module is compatible with the vehicle software configuration involves identifying the software modules that the new software module interfaces with in the vehicle 110. The stub functions for the new software module are compared with the complementary stub functions for each of the software modules that the new software module is expected to interface with to determine whether there is a compatibility match.

If the server 181 determines that the new software module is compatible with the software modules previously installed in the vehicle, the new software module is activated for operation within the vehicle 110 (block 335). If the software configuration management update process 300 had been triggered by a software request flag, the new software module is transmitted from the telematics call center 180 to the telematics unit 120. The telematics unit 120 facilitates the installation of the new software module in the appropriate vehicle component 114,116. If the software configuration management update process 300 had been triggered by the software install flag, the new software module is retained in the vehicle 110.

If the server 181 determines that the new software module is incompatible with the versions of the software modules previously installed in the vehicle, then the server 181 begins the process of determining whether compatible versions of the installed software modules are available for installation in the vehicle 110 (block 340). The server 181 queries the central database 182 to determine whether upgraded versions of the previously installed software modules that the new software module is expected to interface with are available. The server 181 compares the one or more stub functions for the new software module with the complementary stub functions of alternate versions of the previously installed software modules to determine if compatible versions of the installed software modules are available for installation in the vehicle 110.

If the server 181 determines that the new software module is not compatible with any other available versions of the software modules necessary for operation of vehicle functions, the original vehicle configuration is deemed to be the optimal configuration for the vehicle 110 (block 345). If the software request flag triggered the software configuration update management process 300, no further action is taken. If the software install flag triggered the software configuration update management process 300, the previously installed compatible version of the new software module is requested from the telematics call center 180. The telematics call center 180 transmits the compatible version of the software module for reinstallation in the vehicle 110.

If the server 181 determines that the new software module is compatible with available alternate versions of software modules installed in the vehicle 110, the vehicle is reconfigured with the new software module and the compatible versions of the software modules to interface with the new software module (block 350). If the software request flag triggered the software configuration update management process 300, the server 181 transmits the new software module and the compatible versions of the other software modules to the telematics unit 120. In one embodiment, if the software install flag triggered the software configuration update management process 300, the compatible versions of the other software modules are transmitted to the vehicle 110. In another embodiment, if the software install flag triggered the software configuration update management process 300, the new software module is transmitted along with the compatible versions of the other software modules to the vehicle 110. The installation of the received new software module and the compatible versions of the other software modules are synchronized. After either block 345 or 350 is completed, no further action is taken (block 315) The above-described methods and implementation for the vehicle software configuration update management and associated information are example methods and implementations. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

1. A method of managing a software configuration update of a vehicle, the method comprising:
identifying a first software module;
retrieving a vehicle configuration data representative of a first vehicle software configuration;
determining whether the first software module is compatible with the first vehicle software configuration at a call center; and
sending a second vehicle software configuration from the call center to a telematics unit via a wireless network based on the determination.

2. The method of claim 1, wherein identifying the first software module comprises identifying the first software module responsive to a trigger event.

3. The method of claim 2, wherein the trigger event is one of a software request flag generated by the telematics unit or a software install flag generated by the telematics unit.

4. The method of claim 1, wherein retrieving the vehicle configuration data comprises one of retrieving the vehicle configuration data from the telematics unit or retrieving the vehicle configuration data from a call center database.

5. The method of claim 1, wherein determining whether the first software module is compatible with the first vehicle software configuration comprises:
identifying a second software module associated with the first vehicle software configuration; and
determining whether the first software module is compatible with the second software module.

6. The method of claim 5, wherein sending the second vehicle software configuration comprises sending the first software module from the call center to the telematics unit.

7. The method of claim 5, wherein sending the second vehicle software configuration comprises sending a third software module to the telematics unit wherein the third software module is a different version of the first software module.

8. The method of claim 5, wherein sending the second vehicle software configuration comprises sending a fourth module to the telematics unit wherein the fourth module is a different version of the second module.

9. The method of claim 1, wherein the first software module includes a stub function identifying a software interdependency with a second software module.

10. A computer readable medium storing a computer program for managing a software configuration update of a vehicle, comprising:
computer readable code for identifying a first software module;
computer readable code for retrieving a vehicle configuration data representative of a first vehicle software configuration;
computer readable code for determining whether the first software module is compatible with the first vehicle software configuration at a call center; and
computer readable code for sending a second vehicle software configuration from the call center to a telematics unit via a wireless network based on the determination.

11. The computer readable medium of claim 10, wherein the computer readable code for identifying the first software module comprises computer readable code for identifying the first software module responsive to a trigger event.

12. The computer readable medium of claim 11, further comprising computer readable code for selecting the trigger event from one of a software request flag generated by the telematics unit or a software install flag generated by the telematics unit.

13. The computer readable medium of claim 10 wherein the computer readable code for retrieving the vehicle configuration data comprises computer readable code for one of retrieving the vehicle configuration data from the telematics unit or retrieving the vehicle configuration data from a call center database.

14. The computer readable medium of claim 10, wherein computer readable code for determining whether the first software module is compatible with the first vehicle software configuration comprises:
computer readable code for identifying a second software module associated with the first vehicle software configuration; and
computer readable code for determining whether the first software module is compatible with the second software module.

15. The computer readable medium of claim 14, wherein the computer readable code for sending the second vehicle software configuration comprises computer readable code for sending the first software module from the call center to the telematics unit.

16. The computer readable medium of claim 14, wherein the computer readable code for sending the second vehicle software configuration comprises computer readable code for sending a third software module to the telematics unit wherein the third software module is a different version of the first software module.

17. The computer readable medium of claim 14, wherein the computer readable code for sending the second vehicle software configuration comprises computer readable code for sending a fourth module to the telematics unit wherein the fourth module is a different version of the second module.

18. The computer readable medium of claim 10, further comprising computer readable code for interpreting a stub function of the first software module to identity a software interdependency between the first software module and a second software module.

19. A system for managing a software configuration update of a vehicle, the system comprising:
means for identifying a first software module;
means for retrieving a vehicle configuration data representative of a first vehicle software configuration;
means for determining whether the first software module is compatible with the first vehicle software configuration at a call center; and
sending a second vehicle software configuration from the call center to a telematics unit via a wireless network based on the determination.

20. The system of claim 19, wherein the means for identifying the first software module comprises means for identifying the first software module responsive to a trigger event.

21. The system of claim 20, further comprises means for selecting the trigger event from one of a software request flag generated by the telematics unit or a software install flag generated by the telematics unit.

22. The system of claim 19, wherein the means for retrieving the vehicle configuration data comprises means for one of retrieving the vehicle configuration data from the telematics unit or retrieving the vehicle configuration data from a call center database.

23. The system of claim 19, wherein means for determining whether the first software module is compatible with the first vehicle software configuration comprises:
means for identifying a second software module associated with the first vehicle software configuration; and
means for determining whether the first software module is compatible with the second software module.

24. The system of claim 23, wherein the means for sending the second vehicle software configuration comprises means for sending the first software module from the call center to the telematics unit.

25. The system of claim 23, wherein the means for sending the second vehicle software configuration comprises means for sending a third software module to the telematics unit wherein the third software module is a different version of the first software module.

26. The system of claim 23, wherein the means for sending the second vehicle software configuration comprises means for sending a fourth module to the telematics unit wherein the fourth module is a different version of the second module.

27. The system of claim 19, further comprising means for interpreting a stub function of the first software module to identity a software interdependency between the first software module and a second software module.
